(19) United States
(12) Patent Application Publication
(10) Pub. No.: US 2022/0181908 A1
(43) Pub. Date: Jun. 9, 2022

(54) METHOD AND SYSTEM FOR MONITORING THE OPERATING STATE OF HIGH-VOLTAGE DEVICES OF AN ENERGY SUPPLY NETWORK

(71) Applicant: Siemens Energy Global GmbH & Co. KG, Muenchen (DE)

(72) Inventors: Beatrix Natter, Graefelfing (DE); Saskia Baumann, Nuernberg (DE); Marcel Elmer, Nuernberg (DE); Johannes Raith, Passail (AT); Puneet Harminder Singh, Nuernberg (DE)

(21) Appl. No.: 17/599,009

(22) PCT Filed: Feb. 28, 2020
(86) PCT No.: PCT/EP2020/055222

§ 371 Date: Sep. 28, 2021

(30) Foreign Application Priority Data
Mar. 28, 2019 (EP) 19165666.9

(51) Int. Cl. H02J 13/00

(52) U.S. Cl. CPC H02J 13/00002; H02J 2203/20; H02J 13/00022

(57) ABSTRACT

A method for monitoring the operating state of high-voltage devices of an energy supply network includes using sensors on or in the high-voltage devices to capture measured values. The measured values or values derived therefrom are transmitted to communication units via short-range communication connection. Access data are transmitted to a data processing cloud at a query time. The data processing cloud selects communication units dependent on the access data and connects to selected communication units via long-range communication connection. The measured values and/or values derived therefrom are transmitted from the selected communication units to the data processing cloud via the long-range connection. The data processing cloud uses the measured values and/or values derived therefrom for generating a visualization displaying the operating state of the high-voltage devices connected to at least one of the selected communication units via the short-range connection.

The invention relates to a method for monitoring the operating state of high-voltage devices of an energy supply network.

The invention also relates to a system for observing the operating state of high-voltage devices of an energy supply network.

Such a method and such a system are known from WO 2016/023585 A1. Said document describes a method which can be used to monitor the operating state of an energy supply network. For this purpose, sensors are arranged at particular measurement points of the energy supply network, which sensors capture the voltage or the current flowing via the measurement points while obtaining measured values and transmit the measured values to an observation device. The observation device then generates a visualization which is based on the measured values or on values derived from the latter. An application server is also provided and is outside the area of influence of the operator of the energy supply network. The application server can be used to evaluate and/or process the measured values, wherein system status values which indicate the operating state of the energy supply network at the measurement points are formed. The system status values are transmitted from the application server to the observation device, wherein the observation device considers and displays the system status values in the visualization.

DE 20 2018 102 060 U1 discloses the practice of equipping transformers with communication units which can be connected, on the input side, to sensors and, on the output side, to a data processing cloud, with the result that the data processing cloud can be used to make statements on the operating status of the transformer.

The method mentioned at the outset and the system mentioned at the outset have the disadvantage that the high-voltage devices arranged in a distributed manner in the energy supply network cannot be monitored together.

The object of the invention is therefore to provide a method and a system of the type mentioned at the outset which can be used to monitor high-voltage devices of an energy supply network in a simple and cost-effective manner.

The invention achieves this object by means of a method of the type mentioned at the outset, in which sensors which are arranged on or in the high-voltage devices are used to capture measured values, the measured values or values derived from the measured values are transmitted to communication units via a short-range communication connection, access data are transmitted to a data processing cloud at a query time, the data processing cloud selects a number of communication units which is dependent on the access data and connects to the selected communication units via a long-range communication connection, the measured values and/or the values derived from the measured values are transmitted from the communication units to the data processing cloud via the long-range communication connection, the data processing cloud takes the measured values and/or the values derived from the measured values as a basis for generating a visualization which displays the operating state of the high-voltage devices which are connected to at least one of the selected communication units via the short-range communication connection.

Starting from the system mentioned at the outset, the invention achieves the object by virtue of the fact that the system has
sensors which are arranged on or in a high-voltage device and are configured to capture measured values, wherein the measured values or values derived from the measured values indicate the operating state of the high-voltage device,
a communication unit which is connected to a number of sensors via a short-range communication connection,
a data processing cloud which can be connected to the communication units via a long-range communication connection, and
a user unit which can be connected to the data processing cloud with an indication of access data, wherein the data processing cloud connects to selected communication units on the basis of the access data and is configured to take the measured values and/or values derived from the latter as a basis for providing a visualization which displays the operating state of the high-voltage devices which are connected to at least one of the selected communication units.

According to the invention, a user can log in to a data processing cloud with the aid of access data or, in other words, log-in data. The data processing cloud identifies, on the basis of the user data, which high-voltage devices or which communication units are relevant to the user. For this purpose, the data processing cloud has an expedient database which is stored in a memory of the data processing cloud. If the user is, for example, an operator of a particular region or of an energy supply network, the data processing cloud identifies, for example, that the user operates ten transformers, twenty circuit breakers, ten operating switches, five surge arresters and three capacitor batteries. Each of these high-voltage devices has sensors which are connected to at least one communication unit. The data processing cloud connects only to these communication units, which are referred to as selected communication units below, within the scope of the invention.

The connection is effected via a long-range communication connection. In order to establish this connection, the communication unit has a long-range communication device, for example a mobile radio module according to the GPRS or UMTS standard. Said module is used to set up a long-range communication connection, preferably an IP-based data connection, to the data processing cloud. In this case, a provider of a mobile radio service or a telecommunications provider may be interposed, for example, and the long-range communication connection can be established at least partially via a communication network belonging to this provider and/or at least partially via the Internet. Only a very low outlay on configuration or parameterization then arises for establishing the connection. Apart from configuring the long-range communication device using the information needed to set up the long-range communication connection, for example the installation of a SIM card belonging to a telecommunications provider, no further outlay needs to be expended for the individual communication unit.

In contrast, within the scope of the invention, the sensors are connected to the communication unit via a short-range communication connection. The short-range communication connection may be a simple cable, for example. In a manner deviating from this, the short-range communication connection is, for example, a ZigBee, a Bluetooth, a wireless, an AMbus or a WiFi communication connection. The short-range communication connection extends at most over 100 meters.

An electrical energy supply network is used to transmit and distribute electrical energy from the producer to the end consumer. An important task of an energy supply network is to ensure and improve the reliability with which the end consumer is supplied with electrical energy. It is therefore in the interest of the energy supplier to reduce any failures in the supply of electrical energy, for example as a result of short circuits or ground faults. Before a fault occurring in an energy supply network can be eliminated, the operator of the energy supply network must first of all identify that there is actually a fault in the energy supply network. In addition, it is useful if the operator is advised of a possible fault source even before a high-voltage device fails. In this case, the operator is assisted by the invention.

A data processing cloud is intended to be understood here as meaning an arrangement having one or more data storage devices and one or more data processing devices, which can be designed to carry out any desired data processing processes by means of suitable programming. In this case, the data processing devices are generally universal data processing devices, for example servers, which initially do not have any specific design whatsoever in terms of their construction and their programming. The universal data processing device can be upgraded to perform specific functions only by means of programming which is carried out.

Insofar as the data processing cloud has a plurality of individual components, the latter are connected to one another in a suitable manner for data communication, for example by means of a communication network. Any desired data can be supplied to a data processing cloud for data storage and/or processing. The data processing cloud itself in turn provides other devices, for example computer workstations, laptops, smartphones connected to a data processing cloud, with the stored data and/or the events of the data processing which has been carried out. A data processing cloud may be provided, for example, by a computing center or a plurality of networked computing centers. A data processing cloud is usually spatially remote from the high-voltage devices.

The communication unit preferably has at least one analog input and at least one digital input. A plurality of sensors can therefore be connected to a communication unit. The communication unit has, for example, a main processor and an auxiliary processor and a memory unit, in which preprocessed measured values or values derived from the latter can be stored and processed, for example by means of averaging. The measured values from different sensors can therefore be transmitted together from a communication unit to the data processing cloud via a long-range communication connection.

The sensors may be, for example, ammeters, voltmeters, temperature meters, manometers, status indicators of switches (open, closed, fault) or states of fuses (intact, tripped). Within the scope of the invention, the sensors can also capture pressures, viscosities of a medium or status reports of valve states. Within the scope of the invention, it is also possible to use gas sensors which capture, for example, partial pressures of a particular gas. Optical sensors for capturing arcs are also possible within the scope of the invention.

The state data are, for example, conventional log-in data. The state data thus comprise, for example, a username and a password individually assigned to the username.

The data processing cloud expediently has a database which can be used to determine which high-voltage devices are assigned to the respective user of the data processing cloud. The table stores further data which enable a connection between the data processing cloud and the selected communication units.

A visualization within the scope of the invention may fundamentally have any desired configuration. Measured values and/or values derived from the measured values, which were captured or derived before the query time, are advantageously used in the visualization.

So-called dynamic effects can be taken into account and made visible with the aid of measured values or derived values from the past. If, for example, the temperature of an insulating fluid of a transformer as a high-voltage device does not increase continuously, but rather suddenly, for example from one minute to the next, this is certainly an indication of a fault which should be eliminated as soon as possible.

In order to be able to access the measured values which are before the query time and/or values derived from said measured values, at least one memory unit is required. Within the scope of one further development of the invention, this memory unit is provided in the communication unit, for example. According to this variant of the invention, it is not necessary to permanently maintain a long-range communication connection between the communication unit and the data processing cloud. Within the scope of this further development, the measured values or values derived from the latter can be locally stored. The locally stored values are then transmitted to the data processing cloud during the next connection to the latter.

In a further variant of the invention, measured values captured before the query time and/or values derived from said measured values are stored in a memory of the data processing cloud. According to this advantageous further development, either only the data processing cloud or the data processing cloud in addition to the communication units has a memory unit. This central memory unit is used to store the measured values and/or values derived from the latter, for example after a long-range communication connection has been established between the communication unit and the data processing cloud at the query time by the user. In a manner deviating from this, the data processing cloud can connect to each communication unit at fixed intervals in order to access locally stored data in order to store said data in the larger central memory unit. An overflow of the local memories of the communication units is therefore avoided.

According to a further variant of the invention, there is continuously a long-range communication connection between the communication units and the data processing cloud, with the result that the measured values and/or values derived from the latter are continuously transmitted to the memory unit of the data processing cloud and are stored there in order to be able to be displayed in a time-resolved manner at the query time with other data, values or information.

According to one preferred further development of the invention, the visualization is generated with the aid of a quotient of the load current to the nominal current based on the respective high-voltage device. In this case, the load current is the current which is actually captured by the sensors and flows through a high-voltage winding or via a high-voltage switch, for example. The nominal current is the current which is intended to flow via the respective high-voltage device. In other words, the nominal current is a predefined parameter. If the quotient of the load current to the nominal current exceeds a threshold value, for example 1.5, the visualization can illustrate this with the aid of a particular color of the high-voltage device. If the high-voltage device is a transformer, for example, the latter is illustrated, for example, in a highly schematic manner with its housing and its bushings. If the quotient of the load current to the nominal current is 1, the transformer is green. However, if the quotient exceeds 2, a red illustration of the transformer is selected, which is intended to be used to indicate the critical state of the transformer. In addition, if the threshold value, for example 2, is exceeded, a warning signal can be transmitted from the data processing cloud to the user.

The data processing cloud advantageously identifies when such a limit value is exceeded even when the user is not connected to the data processing cloud. In this case, the data processing cloud can transmit a warning SMS, an email or another signal to a mobile telephone or to a monitoring station, for example.

According to a further advantageous configuration of the method according to the invention, measured values which are before the query time in terms of time and/or values derived from said measured values are displayed in a graph in a manner correlated with data which are not derived from the measured values from the sensors. These data are, for example, temperature values which have been obtained from a weather service connected to the Internet. In addition, wind strengths, solar radiation values or other influencing variables of the status of the high-voltage devices can be taken into account. The measured values of other high-voltage devices may also be taken into account and displayed over time.

According to one preferred variant of the invention, a map, on which the high-voltage devices connected to the selected communication units are schematically illustrated, is displayed in the visualization. As already indicated further above, a transformer, for example, can be displayed in the visualization in a simplified manner by means of a symbol. A corresponding situation applies to a circuit breaker, an isolating switch, a capacitor battery, a surge arrester or other high-voltage devices.

If the user is, for example, an operator of an energy supply network and is responsible for a number of transformers, circuit breakers, capacitor batteries, spark gaps or the like, his high-voltage devices are displayed geographically together on the map. The user therefore obtains a good overview of the high-voltage devices for which he is responsible.

A prediction of the further progression of the utilization and service life of the high-voltage devices is advantageously generated on the basis of the measured values which are before the query time and/or values derived from said measured values, wherein this prediction is likewise schematically displayed in the visualization. If, for example, the occurrence of an arc in a transformer tank or a circuit breaker is monitored with the aid of a camera, a prediction of the length of time for which maintenance of the respectively monitored high-voltage device can still be deferred or when exactly this maintenance should take place can be made with the aid of the captured arcs and a simple extrapolation or a more complex simulation.

Both measured values or values derived from the latter which are before the query time and measured values which are captured approximately at the query time and/or during a session of the user in the cloud are taken into account in this prediction.

The consideration of measured values in the past increases the accuracy of the prediction.

A position determination antenna which is arranged in the communication unit is advantageously used to determine the geographical location of the respective communication unit and of the high-voltage device connected to the latter, and the weather conditions are determined by a weather message service on the basis of the geographical data. According to this advantageous further development, the weather conditions need not be captured in situ in a complicated manner. Rather, within the scope of the invention, it is possible to resort to data which are available anyway, for example on the Internet. The data relating to the weather conditions obtained in this manner can likewise be shown in the visualization.

According to one advantageous further development of the system, the data processing cloud has a memory unit which continuously stores measured values and/or values derived from the measured values, which are transmitted from the communication units via a long-range communication connection. As already stated further above, the long-range communication connection may be continuous or, in other words, permanent. In a manner deviating from this, however, it is also possible, within the scope of the invention, to set up the long-range communication connection at particular intervals in order to transmit data blocks of measured values which were captured and locally stored between query intervals.

Each communication unit expediently has a memory unit which continuously stores measured values and/or values derived from the measured values, wherein, at a query time, measured values which are before the query time in terms of time and/or values derived from said measured values are transmitted to the data processing cloud.

Each communication unit is advantageously equipped with a position determination antenna.

The following description of exemplary embodiments of the invention with reference to the figures of the drawing relates to further expedient configurations and advantages of the invention, wherein identical reference signs refer to identically acting components, and wherein

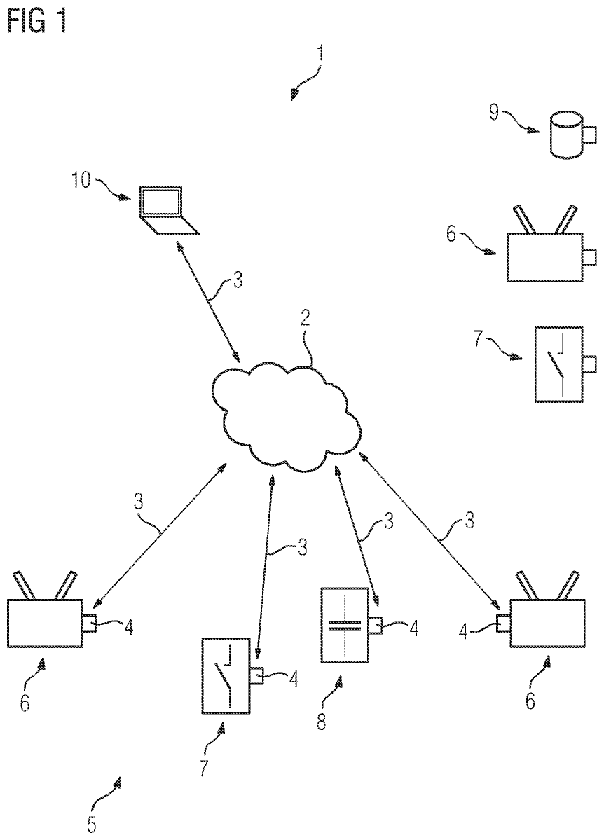

FIG. 1 schematically illustrates an exemplary embodiment of the method according to the invention and of the system according to the invention, and

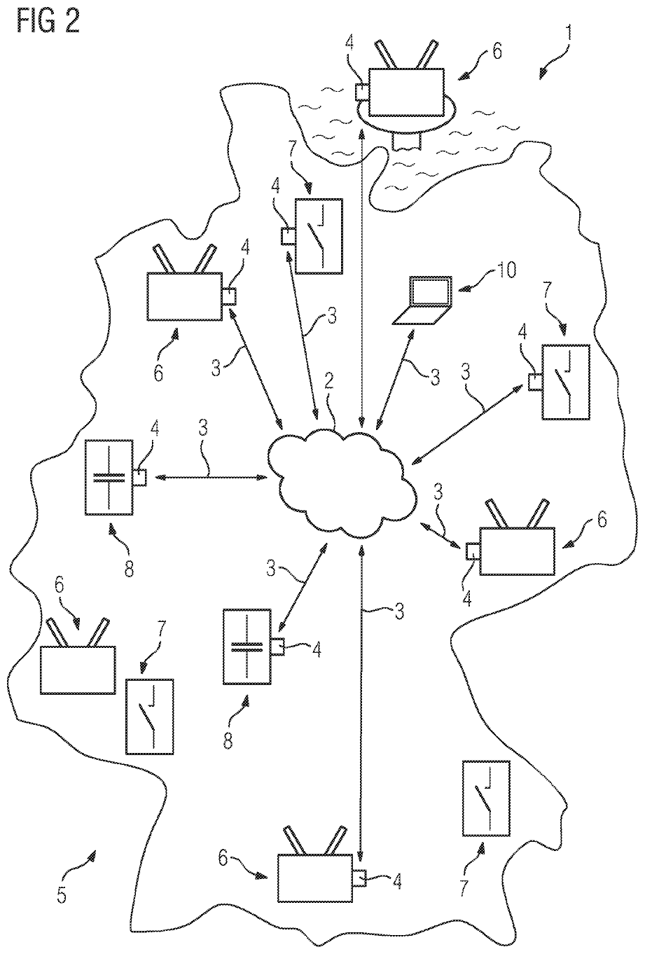

FIG. 2 schematically illustrates a further exemplary embodiment of the method according to the invention and of the system according to the invention.

FIG. 1 shows an exemplary embodiment of the method 1 according to the invention, in which it is possible to see a data processing cloud 2 which is connected, via a long-range communication connection 3, to communication units 4 which are each fastened on or in the vicinity of a high-voltage device 5. In the exemplary embodiment illustrated, the high-voltage devices 5 are a transformer which is schematically shown with its column-like bushings, a high-voltage circuit breaker 7 and a capacitor battery 8. It is also possible to see a user unit in the form of a laptop 10 which is used by the user to transmit access data to the data processing cloud 2 via a long-range communication connection 3. In the exemplary embodiment shown, the access data comprise a username and a password permanently assigned to the username.

The data processing cloud 2 also has a memory unit which is not illustrated in the figures and stores a database. The database stipulates which high-voltage devices 5 are assigned to the access data, that is to say the username in this case. If the user is, for example, the operator of an energy supply network having a number of high-voltage devices in the form of transformers, circuit breakers, isolators or surge arresters for which he is responsible, he can connect to the data processing cloud 2 by inputting his access data. The data processing cloud determines, on the basis of the username, whilst accessing said database, which high-voltage devices fall within the area of responsibility of the user. The data processing cloud 2 then accesses, via a long-range communication connection 3, the communication units 4 which are arranged in the vicinity of the high-voltage devices 5 assigned to the username. These communication units 4 are referred to as selected communication units 4. Each communication unit 4 has a plurality of inputs which are both analog and digital, for example. A sensor which is arranged on the sensor or in the high-voltage device is connected to at least one of the inputs, which sensor captures measured values and transmits these measured values to the communication unit via a short-range communication connection which is not illustrated in the figures.

In the example shown, a plurality of sensors are provided in the transformer 6. A sensor captures the temperature of the insulating fluid, here an ester, in the upper region of the tank. A further sensor captures the temperature of the insulating fluid in the lower region of the tank. A further sensor captures the currents flowing through the high-voltage winding, whereas a further sensor is a camera which records the occurrence of spark discharges. All sensors transmit their measured values or values derived from the latter to the communication unit 4 which processes these measured values. For this purpose, the communication unit 4 has expedient processors and a memory unit which buffers the captured measured values and/or the values derived from the latter. The measured values are processed here by the communication unit by means of expedient averaging over a certain period. The communication unit 4 locally stores the averaged values in its memory unit. The measured values can therefore be stored in the communication unit 4 for weeks, for example.

If the user uses his laptop 10 to access the data processing cloud 2 at a query time, the values stored in the communication unit 4 before this query time are transmitted to the data processing cloud 2. The data processing cloud 2 stores the transmitted data in its memory units not illustrated in the figures. The values stored there or, in other words, data can now be taken into account in an expedient visualization, for example.

Each communication unit 4 also has an antenna which makes it possible to determine the position of the communication unit 4. The communication unit 4 is arranged in the vicinity of the respective high-voltage device 5, that is to say less than 100 m away. In other words, the geographical location of the respective high-voltage device can also be captured by determining the position of the communication unit 4. This is carried out by means of a position determination system, for example GPS, Galileo or the like. If the geographical location of the high-voltage device has been determined, the data processing cloud 2 accesses weather data available for this location by virtue of the data processing cloud 2 accessing the database of a weather service in order to determine, for example, solar radiation, wind strength and outside temperature at the location of the respective high-voltage device.

FIG. 2 shows a further exemplary embodiment of the method according to the invention and of the system according to the invention, in which the geographical location of the respective high-voltage device 5 is shown on a map of Germany. It can be seen that not all high-voltage devices 5 are connected to the data processing cloud 2 via a long-range communication connection 3. Rather, some high-voltage devices 5 are decoupled from the data processing cloud 2. These high-voltage devices which are not connected do not fall within the area of responsibility of the user connected to the data processing cloud 2 via his input unit 10. The high-voltage devices 5 or communication units 4 which are not selected are assigned to a different network operator.

In order to better illustrate the status in the high-voltage devices 5, colored displays are used within the scope of the invention. According to one preferred embodiment of the invention, the current flowing via the respective transformer 6 is captured as the load current. The nominal current provided by the network operator, that is to say the intended target current, is stored as a parameter in the database of the data processing cloud 2. The data processing cloud 2 accesses this nominal current parameter and forms the quotient of the captured load current and said nominal current. If this quotient exceeds a predefined threshold value, for example 1.5 or 2, the color of the displayed transformer 6 changes from green to yellow, for example. If said quotient exceeds a further threshold value, for example 2.5, the transformer is displayed in red and a warning signal is transmitted to the laptop or a mobile telephone belonging to the user by the data processing cloud 2.

However, the visualization of the data processing cloud 2 is in no way restricted to geographical locations. The data processing cloud 2 can correlate the measured values captured by the sensors of the high-voltage devices 5 with any desired data obtained by the data processing cloud 2 from the so-called Internet. In addition, predictions are possible with the aid of simulation tools.

1-15. (canceled)

16. A method for monitoring an operating state of high-voltage devices of an energy supply network, the method comprising:
using sensors disposed on or in the high-voltage devices to capture measured values;
transmitting the measured values or values derived from the measured values to communication units over a short-range communication connection;
transmitting access data to a data processing cloud at a query time;
using the data processing cloud to select a number of the communication units being dependent on the access data and to connect to the selected communication units over a long-range communication connection;
transmitting at least one of the measured values or the values derived from the measured values from the selected communication units to the data processing cloud over the long-range communication connection; and
using the data processing cloud to take at least one of the measured values or the values derived from the measured values as a basis for generating a visualization displaying the operating state of the high-voltage devices connected to at least one of the selected communication units over the short-range communication connection.

17. The method according to claim 16, which further comprises using, in the visualization, at least one of the measured values or the values derived from the measured values having been captured or derived before the query time.

18. The method according to claim 17, which further comprises storing, in a memory unit of the communication unit, at least one of the measured values captured before the query time or the values derived from the measured values.

19. The method according to claim 17, which further comprises storing, in a memory of the data processing cloud, at least one of the measured values captured before the query time or the values derived from the measured values.

20. The method according to claim 16, which further comprises using a quotient of a load current to a nominal current based on a respective high-voltage device, to aid in generating the visualization.

21. The method according to claim 16, which further comprises displaying at least one of the measured values occurring before the query time in terms of time or the values derived from the measured values, in a graph in a manner correlated with data not being derived from the measured values from the sensors.

22. The method according to claim 16, which further comprises displaying in the visualization a map on which the high-voltage devices connected to the selected communication units are schematically illustrated.

23. The method according to claim 16, which further comprises generating a prediction of a further progression of a utilization and service life of the high-voltage devices based on at least one of the measured values captured before the query time or values derived from the measured values, and displaying the prediction in the visualization.

24. The method according to claim 16, which further comprises using a position determination antenna disposed in a communication unit to determine a geographical location of the respective communication unit and of the high-voltage device connected to the respective communication unit, and then capturing weather data provided by a service provider for the geographical location of the high-voltage device by using a weather message service.

25. A system for observing an operating state of high-voltage devices of an energy supply network, the system comprising:
sensors disposed on or in a high-voltage device and configured to capture measured values, at least one of the measured values or values derived from the measured values indicating the operating state of the high-voltage device;
communication units;
a short-range communication connection connecting said communication units to at least one of said sensors;
a data processing cloud;
a long-range communication connection configured to connect said data processing cloud to said communication units;
a user unit configured to be connected to said data processing cloud with an indication of access data;
said data processing cloud connected to selected communication units based on the access data and configured to take at least one of the measured values or the values derived from the measured values as a basis for providing a visualization displaying the operating state of the high-voltage devices connected to at least one of said selected communication units.

26. The system according to claim 25, wherein said data processing cloud has a memory unit storing at least one of measured values or values derived from the measured values being transmitted from said communication units over said long-range communication connection.

27. The system according to claim 25, wherein each communication unit has a memory unit storing at least one of measured values or values derived from the measured values, and at least one of measured values occurring before a query time in terms of time or values derived from the measured values being transmitted to said data processing cloud at the query time.

28. The system according to claim 25, wherein each communication unit is equipped with a position determination antenna.

29. A non-transitory computer program product, comprising instructions stored thereon, that when executed on a processor, perform the steps of claim 16.

30. A non-transitory computer-readable medium storing a computer program according to claim 29.
